(19) United States
(12) Patent Application Publication
(10) Pub. No.: US 2014/0129363 A1
(43) Pub. Date: May 8, 2014

(54) DYNAMIC RATING RULES FOR AN ONLINE MARKETPLACE

(71) Applicant: MICROSOFT CORPORATION, Redmond, WA (US)

(72) Inventors: Paul Lorah, Redmond, WA (US); Stanley Chen, Redmond, WA (US); Scott Clifford, Redmond, WA (US); Zoe Wydroug, Seattle, WA (US); Todd Ostermeier, Kenmore, WA (US)

(73) Assignee: MICROSOFT CORPORATION, Redmond, WA (US)

(21) Appl. No.: 13/666,969

(22) Filed: Nov. 2, 2012

(51) Int. Cl. G06Q 30/00

(52) U.S. Cl. 705/26.1

(57) ABSTRACT

In an online marketplace, merchants are rewarded when they contribute successful goods or services, or otherwise contribute to the overall value of the marketplace to purchasers and to the marketplace provider. In particular, a dynamic rating rule is provided that allows revenue sharing to vary dynamically depending on factors such as item price, item volume and transaction type. The dynamic rating rule applied to a transaction can include a primary rule and one or more secondary rules. For example, a primary rule can define a percentage share based on price of an item, and a secondary rule can define an additional percentage share based on total sales of that item for the merchant. Thus different rating rules can apply to different items at different price points and at different sales volumes. As a result, a merchant can receive a higher percentage share of revenue with items with higher prices or higher volumes.

### BACKGROUND

In an online marketplace, a marketplace provider enables merchants to engage in transactions of goods and services with purchasers through the online marketplace. The marketplace typically is a form of computer system accessible by the merchants and purchasers, such as one or more web servers accessible through the internet. Merchants access the computer system to provide information about goods and services that it is providing. Purchasers access the computer system to identify goods and services available from merchants, and engage in transactions with the merchants such as purchasing goods or services.

Generally, in connection with any given transaction, the purchaser pays the marketplace provider in their local currency. The marketplace provider in turn compensates the merchant, generally providing the merchant with a share of the revenue generated by the transaction, typically defined contractually as a percentage share of the revenue, such as the sale price, from a transaction. This price may or may not include taxes, shipping, currency exchange and other expenses. The marketplace provider is compensated by retaining any remaining revenue generated by a transaction.

In many cases the percentage share received by a merchant is fixed, regardless of the volume, variety and price of the goods and services provided. However, transaction costs can vary depending on such factors. Generally, items having lower cost or lower volume have transaction costs that are a higher percentage of the transaction value than items with higher cost or higher volume.

### SUMMARY

This Summary is provided to introduce a selection of concepts in a simplified form that are further described below in the Detailed Description. This Summary is intended neither to identify key or essential features of the claimed subject matter, nor to limit the scope of the claimed subject matter.

In an online marketplace, it can be desirable to reward merchants who contribute successful goods or services, or otherwise contribute to the overall value of the marketplace to purchasers and to the marketplace provider. Accordingly, a dynamic rating rule is provided that allows revenue sharing to vary dynamically depending on factors such as item price, item volume and transaction type. The dynamic rating rule applied to a transaction can include a primary rule and one or more secondary rules. For example, a primary rule can define a percentage share based on price of an item, and a secondary rule can define an additional percentage share based on total sales of that item for the merchant. Thus different rating rules can apply to different items at different price points and at different sales volumes. As a result, a merchant can receive a higher percentage share of revenue with items with higher prices or higher volumes.

The rating models can be defined to support an arbitrary number of currencies. For example, a set of price tiers can be defined which provide equivalent sale values across currencies. Each item sold in the marketplace is associated with a price tier for the purpose of the dynamic rating rules, eliminating the need to define rating rules in each currency. Further, the total value of sales of a given item can be accurately estimated, without the need for foreign currency conversion.

In one aspect, a primary revenue sharing rule is applied to obtain a base amount of compensation for the merchant. This primary rule can be based on price tiers or can be fixed. Then, one or more secondary revenue sharing rules are applied to obtain an additional amount of compensation for the merchant. The secondary rules are applied if a condition of the rule has been met, such as whether a sales tally for the item in the transaction has exceeded a threshold.

In another aspect, sales tallies for item are maintained in a currency-independent format. Decisions, such as when to pay a merchant or to apply a secondary revenue sharing rule, can be made using such sales tallies. Updating the sales tally for the item in the transaction involves updating the sales tally for the item using an amount in a currency that corresponds to the price tier for the transaction, but can be different from the currency used in the transaction.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a data flow diagram of an example online marketplace system with dynamic rating rules.

FIG. 2 is a data flow diagram illustrating an example implementation of a seller input module for the online marketplace system.

FIG. 3 is a diagram of an example price tier table used in dynamic rating rules.

FIG. 4 is a diagram of an example dynamic rule table, relating price tiers to primary rules.

FIG. 5 is a diagram of a simplistic example of an offering database for an online marketplace.

FIG. 6 is a diagram of a simplistic example of a transaction database for an online marketplace.

FIG. 7 is a flow chart describing an example implementation of applying dynamic rating rules.

FIG. 8 is a diagram of an example product sales tally table.

FIG. 9 is a diagram of an example dynamic rule table, relating price tiers to secondary rules.

FIG. 10 is a data flow diagram of an example implementation for a sales tally module.

FIG. 11 is a flow chart describing an example implementation of applying secondary rating rules using sales tally information.

FIG. 12 is a block diagram of an example decision module using sales tally information.

FIG. 13 is a block diagram of an example computing device in which such a system can be implemented.

### DETAILED DESCRIPTION

The following section provides an example operating environment for implementing an online marketplace with dynamic rating rules.

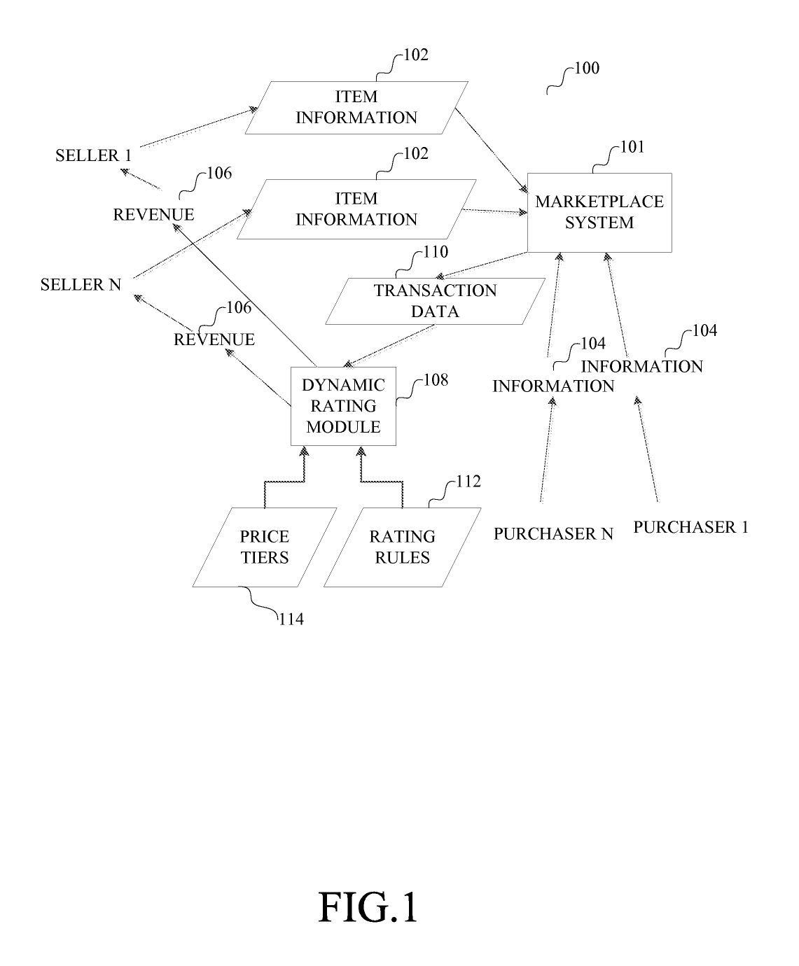

Referring to FIG. 1, an online marketplace 100 is a computer system that supports having a plurality of merchants (labeled Seller 1 through Seller N) provide goods and services to a plurality of purchasers (labeled Purchaser 1 though Purchaser N). The online marketplace typically includes multiple computers implementing different pieces of a marketplace system 101, such as one or more servers used by purchasers, one or more servers used by merchants, various databases and the like. The invention is not limited to any particular configuration of computer systems to implement the online marketplace 100.

The marketplace system 101 that receives information from merchants and purchasers to facilitate transactions in goods and services. For a merchant to offer goods and services to purchasers in the online marketplace, the merchant provides item information 102 (typically from a seller's computer that is accessing the online marketplace) to the marketplace system 101. The item information 102 includes a description of the goods and services provided by the merchant, and a price. The marketplace system 101 also receives information about the merchant, such as contact information. The information from the merchant is stored in various databases, examples of which are described below, accessible by the marketplace system 101. Such information is obtained and maintained by the marketplace system 101 for a plurality of merchants, for a plurality of goods and services.

For a purchaser to engage in transactions with respect to goods and services from merchants, typically by buying goods and services, the purchaser provides purchase information 104. The purchase information includes information from the purchaser identifying an item to be purchased, a price and a quantity. The marketplace system 101 also receives information about the purchaser, such as billing information. The marketplace system 101 then stores transaction information 110 in various databases, examples of which are described below. Such transaction information is obtained and maintained by the marketplace system for a plurality of transactions, from a plurality of purchasers, for a plurality of goods and services from a plurality of merchants.

To determine the compensation 106 provided to a merchant, a dynamic rating module 108 accesses transaction information 110 stored by the marketplace system and applies dynamic rating rules 112 to such transaction information. The dynamic rating rules specify the compensation 106 due to a merchant given a transaction. The compensation can be dependent on, for example, sales price, total sales, type of transaction or other factor. The dynamic rating module 108 updates a database (not shown) with the compensation 106 that has been computed. The compensation is paid by the marketplace provider to the merchant in accordance with their contract.

In one implementation, the dynamic rating module uses price tiers 114 to define a primary rule for compensating the merchant for a transaction. Each price tier defines a price at which the item is offered. How price tiers can be defined and stored for multiple currencies is described in more detail below. For different price tiers, the marketplace can set different percentage shares in revenue as a primary rule. In another implementation, one or more secondary rules can be defined. For example, an additional percentage share in revenue can be given to the merchant when total sales for an item, or set of items, exceeds a threshold. Such examples are described in more detail below. Primary rules and secondary rules can be defined independently of each other, for example, by being based on different factors. For example, primary rules can be associated with price tiers and secondary rules can be associated with total sales. While the term “primary” and “secondary” is used herein, another implementation uses a fixed primary rule for all price tiers, and has only secondary rules that vary compensation based on other factors.

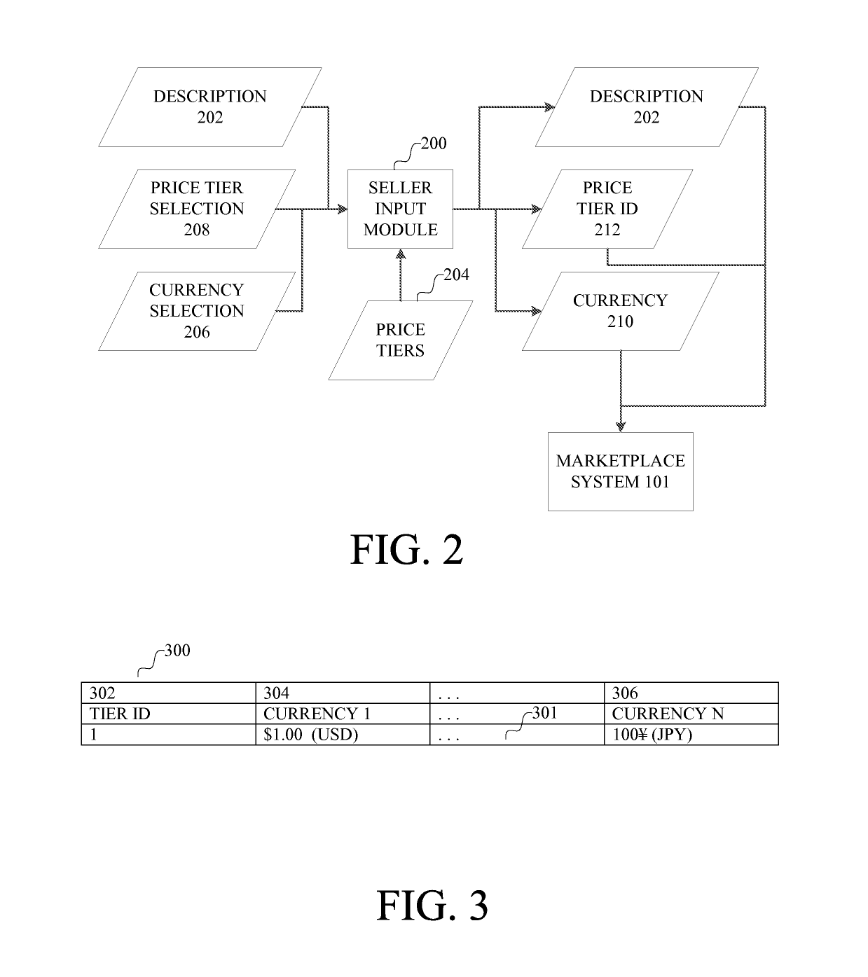

The price tiers 114 also can be used to present options to merchants to allow the merchants to set prices for their goods and services. Referring to FIG. 2, a seller input module 200 receives item information, such as a description 202 and information about the price tiers 204. In one implementation, a merchant can provide a currency selection 206, indicating a currency with which the merchant is familiar. The merchant can be presented with pricing options, based on the price tiers 204 and currency selection 206, such as through a graphical user interface. The merchant provides an input indicating a selected price tier. For example, if the merchant is familiar with pricing in Japanese yen (JPY), then price tiers can be displayed in JPY in response to such information from the merchant, and the merchant can select a price tier. Alternatively, the system can present a list of price tiers without a currency selection from the merchant, from which list the merchant can select a price tier. Given a price tier selection 208, the seller input module provides the description 202, (optional) currency 210 and price tier identifier 212, for the merchant to the marketplace system 101 for storage and use.

Given this context, an example implementation of an online marketplace using dynamic rating rules will be described in more detail in connection with FIGS. 3-12.

Referring now to FIG. 3, an example implementation of price tiers will be described. In this example, a price tier table 300 defines multiple price tiers, each with an identifier 302. Each row 301 defines a tier. Tiers are set at suitable pricing intervals. Each column, e.g., 304, 306 specifies an amount in a currency that corresponds to that tier. Each of the amounts specified for a tier are set to that they are approximately equivalent, based on currency exchange rates and rounding, such that the amounts are appropriate from a marketing perspective. For example, a price tier that is defined by a currency exchange calculation at $1.91 U.S. dollars (USD) can be rounded to be $2.00 USD. The price tiers can be recalculated based on new exchange rates as desired, but such calculation can occur infrequently because the tiers are intended to provide relative equivalence of price ranges across currencies for the purposes of defining price tiers and rules for compensation.

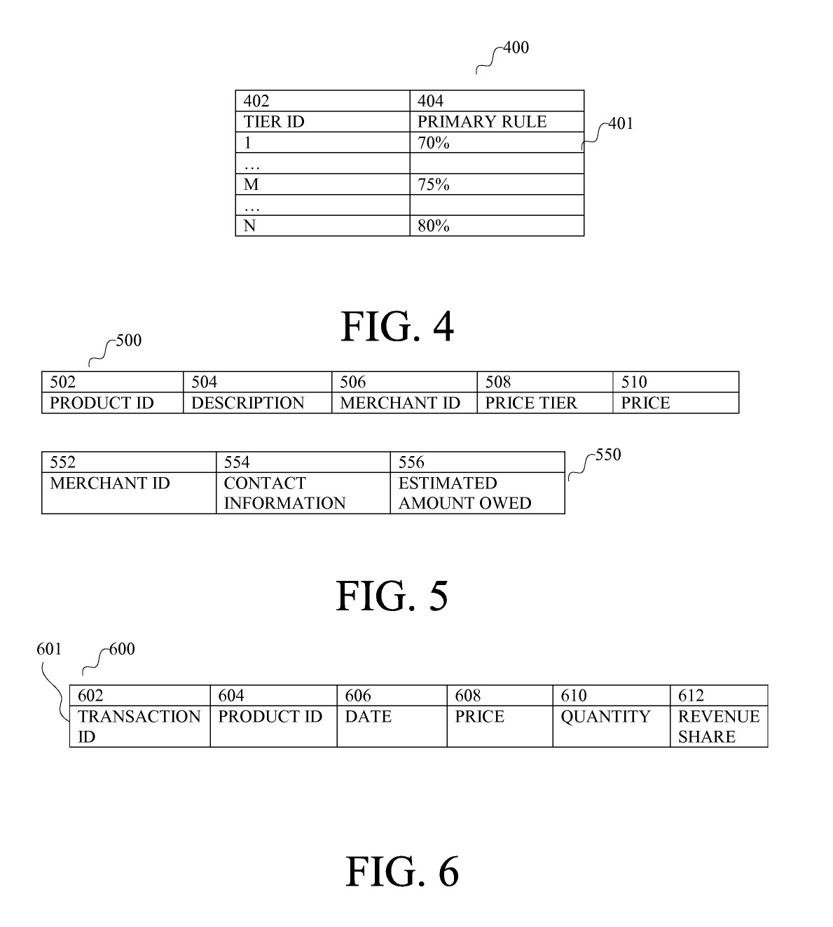

Referring now to FIG. 4, how dynamic rating rules, i.e., compensation rules, are defined by tiers will now be described.

In the example implementation in FIG. 4, a dynamic rule table 400 includes a row 401 for each price tier, allowing each price tier to have its own compensation rule. Each row includes a column 402 indicating the price tier identifier. A column 404 includes an identifier of a primary rule, or data defining the primary rule itself, such as a percentage share for the merchant to receive on sales on items in that price tier. For example, the rating rule for items sold in a price tier corresponding to $1.00 USD can be set to 70%. For another price tier, such as one corresponding to $15.00 USD, a different rating rule can be set, e.g., 80%. Each tier can be defined with its own rating rule. The same rating rule percentage can be specified for any number of price tiers for which consistent treatment is desired. In one implementation, column 404 includes an identifier of a primary rule, and a separate database table maps the primary rule identifier to data that defines the primary rule. In another implementation, one or more columns 404 include data that defines the primary rule for each price tier.

One or more additional, secondary rating rule(s) also can be defined and applied to transactions. In general, a secondary rule applies when additional conditions are met, based on factors such as total sales or type of transaction, and can be independent of price tiers. Thus secondary rules are not shown in FIG. 4. If the condition for a secondary rule is met, then the percentage share to the merchant for the transaction is adjusted. Example secondary rating rules are described in more detail below.

To help describe a range of possibilities for secondary rating rules, further details of an example implementation of an online marketplace will first be described.

As noted above, the marketplace system maintains databases about the product and service offerings from merchants, and transactions related to those product and service offerings. By way of a simplified example, referring to FIG. 5, the product and service offerings are maintained in an offering database that includes, for example, an item table 500 and a merchant table 550. In the example item table, various information about goods and services is stored. For example, the item table can, for each good or service offered, include a product identifier 502, a description 504, an identifier of the merchant 506, a price tier identifier 508, and other information such as price and quantity. The offering database tracks the relationship between a product and its price tier. The merchant table stores, for each merchant, a merchant identifier 552 and contact information 554. The merchant table also can indicate whether the merchant receives a fixed revenue share or is participating in the dynamic revenue sharing rules.

An estimated amount owed 556 from the marketplace provider to the merchant also can be stored so that the merchant table can track a relationship between a merchant and an estimated amount owed, for deciding when a payout should occur. This estimated amount owed is updated periodically using the dynamic rating rules as applied to transactions involving the merchant's goods and services. When the estimated amount owed reached a threshold, an actual payout amount can be computed per the contract with the merchant, and the merchant can be paid. In one implementation, the estimated amount owed can be tracked in each currency (for transactions in that currency), and when the estimated amount in one currency reaches a threshold, amounts for transactions in all currencies can be paid out.

As noted above, FIG. 5 is a simplified example and the invention is not limited to any specific database structure for tracking item information or merchant information.

The marketplace system also maintains a transaction database, which stores information about transactions, a simplified example of which is shown in FIG. 6. As such, the invention is not limited to any specific database structure for tracking information about transactions. However, the transaction database 600 is generally the source of data which identifies, for each transaction (indicated by a row 601, a transaction identifier 602, a good or service 604, a date 606 the good or service was sold, a quantity 610, a price 608 for the transaction. The revenue share owed the merchant for the transaction also can be stored in column 612. Other information about the transaction can include, but is not limited to, a price tier identifier and a transaction type. A type of transaction can include the form of payment (cash, credit, debit, check), or the place the transaction occurred (in-store, online), or manner of delivery. The transaction type also can be used to indicate a return. The product identifier, quantity and price tier can be used to maintain information about total sales, as described in more detail below.

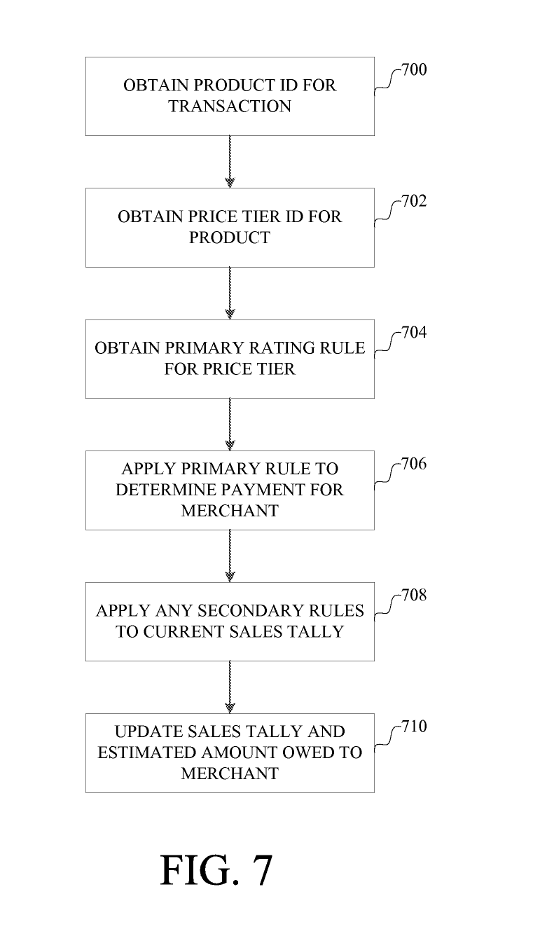

Given such an online marketplace that maintains information about goods and services, merchants and transactions, and a dynamic rating model, the compensation for each of multiple merchants can be determined for transactions involving that merchant's goods or services. An example process is shown in FIG. 7.

In FIG. 7, an example process implemented by the dynamic rating module involves, for a transaction, obtaining 700 the product identifier for the good or service in the transaction. Given the product identifier, a price tier identifier and merchant identifier for that product can be obtained 702. The primary rating rule for that price tier is then obtained 704. The primary rating rule also can be a function of the transaction type, and different types of transaction for the same item can provide different primary revenue sharing amounts. The dynamic rating module applies 706 the primary rule to the transaction to determine the payment for the merchant. Any secondary rating rule(s), if applicable, can be applied 708, for example, using any current sales tally for the item (as described in more detail below). An estimated amount owed to the merchant, such as column 612 in FIG. 6 and/or column 556 in FIG. 5, and any sales tally, then can be updated 710.

When the process of FIG. 7 is applied is up to the implementation of the online marketplace. In general, the estimated amount owed to a merchant can be determined at the time the transaction is made, or can be determined for a batch of transactions at periodic intervals, such as every half hour, every hour, every day or other suitable interval.

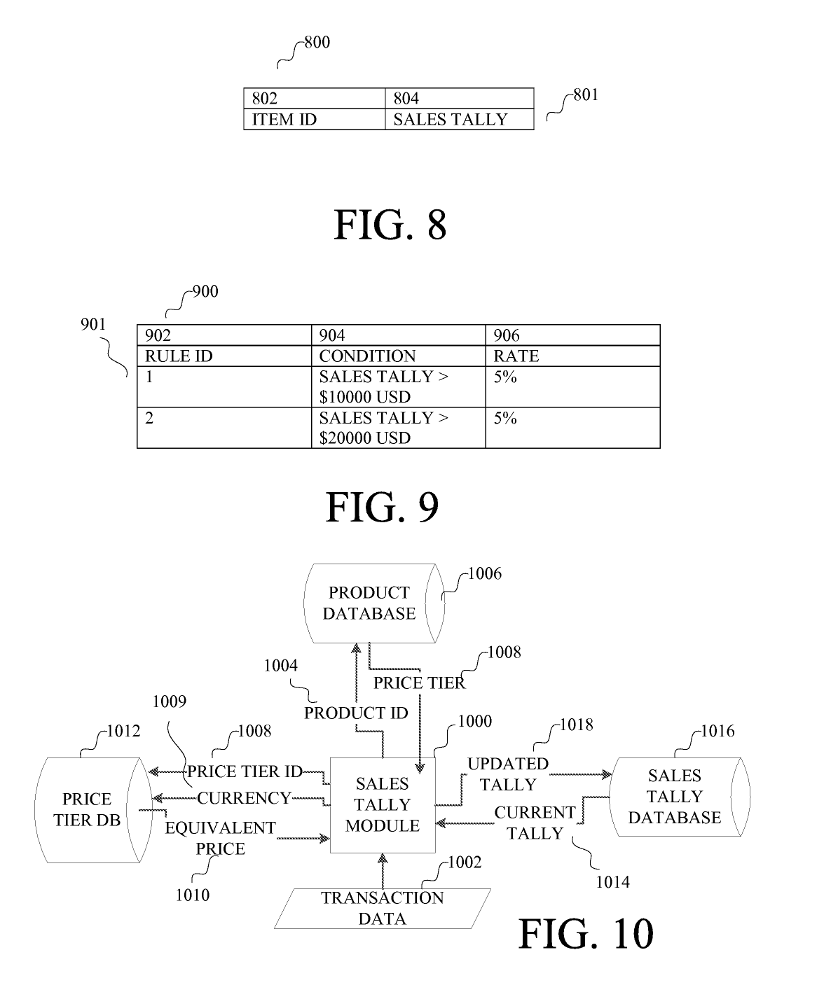

An additional action that can occur for each transaction is updating a product tally indicative of total sales for a good or service, or group of goods and services, of a merchant. A database of product tallies can be maintained as shown at 800 in FIG. 8. This information can be maintained separately from the offering database (FIG. 5) or merchant database (FIG. 6), or as part of the offering database or merchant database. In general, each row 801 represents a good or service, each of which has an item identifier. For each item identifier 802, a tally of sales 804 of the product is maintained. After each transaction is processed, this database can be updated. A return decrements the tally, whereas a sale increments the tally. The tally can be updated by the total value of the sale or by a function of the total value of the sale. For example, there can be rules applied to count only a percentage of the sale towards and adjustment of the tally. The sales tally can be in terms of units or in currency. If maintained in currency, it can be maintained in one currency related to the price tier for the item. By maintaining the tally in currency, the merchant can change the price tier for the item without impacting the current sales tally for the item. For example, if a product is sold and the transaction is in Japanese yen (JPY), but if the sales tally is maintained in United States dollars (USD), then the price tier database can be used to provide an appropriate value to increment the sales tally in USD given the price of the transaction in JPY.

Referring now to FIG. 9, secondary rules can be defined for different sales tally ranges. For example, a secondary rule table 900 can include a row 901 for each sales range or other condition. A rule identifier is provided in column 902. The condition, such as a sales range, is defined in one or more columns 904. A secondary rule for that condition or sales range is defined in column 906. The secondary rule can be defined by a rule identifier, which references another database that maps the rule identifier to data defining the rule. Alternatively, data defining the rule can be present in column 906. As shown in FIG. 9, if the sales tally of an item is over $10000 (USD), then an additional 5% is given to the merchant, and if the sales tally exceeds $20000 (USD), then an additional 5% is given to the merchant. Such rules in this example are one way to implement a revenue sharing model in which the first $10000 (USD) of units sold are rated at 70%, the next $10000 (USD) of units sold are rated at 75% and any additional units sold are rated at 80%. In this example, the application of the rules is described as cumulative (both of the secondary rules are applied). Alternatively, secondary rules can be defined so that only one is applied. For example, a similar result can be achieved by defining a first secondary rule for the range of $0-$10000 at 0%, a second secondary rule for the range of $10001-$20000 at 5%, and a third secondary rule for the range of >$20001 at 10%. Other conditions can be present in column 902 to define other secondary rules based on factors other than sales range.

An example implementation of a sales tally module that maintains the sales tally is shown in FIG. 10. For example, the sales tally module 1000 receives transaction data 1002 from the online marketplace. Given a product identifier 1004, the product database 1006 can be accessed to obtain a price tier identifier 1008. Given the price tier identifier 1008 and a currency 1009, an equivalent price 1010 used for sales tallies can be obtained from the price tier table 1012. Given the equivalent price 1010, and the current tally 1014 from the sales tally database 1016, the sales tally can be updated, as indicated at 1018.

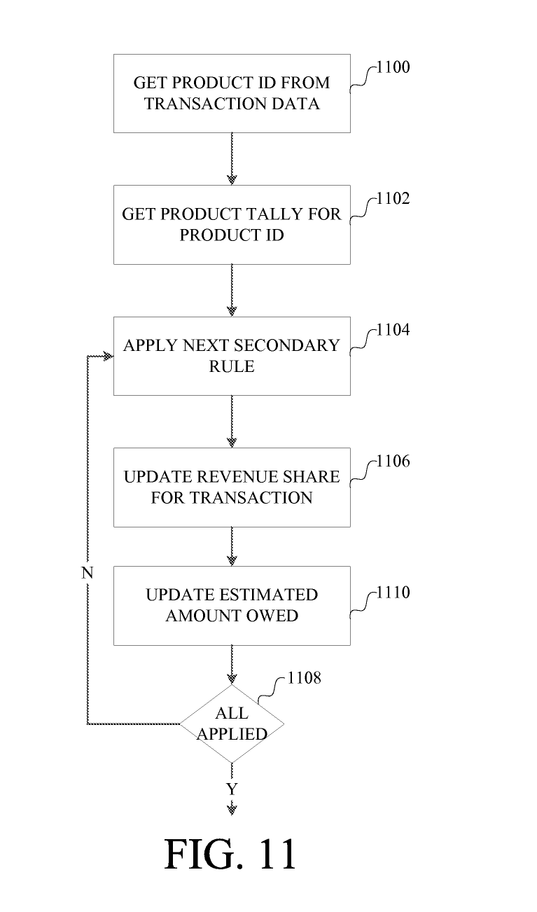

A flowchart describing this process of applying secondary rules using the sales tallies will now be described in connection with FIG. 11. A product identifier is obtained 1100 from the transaction data. A sales tally for that product identifier is obtained 1102 from the sales tally table. Secondary rules are then applied 1104 give the sales tally for the product. The revenue share for that transaction is updated 1106. Any estimated amount owed to the merchant also can be updated 1110. If more secondary rules remain to be applied, as determined at 1108, the process continues as indicated at 1104, until all the secondary rules are applied.

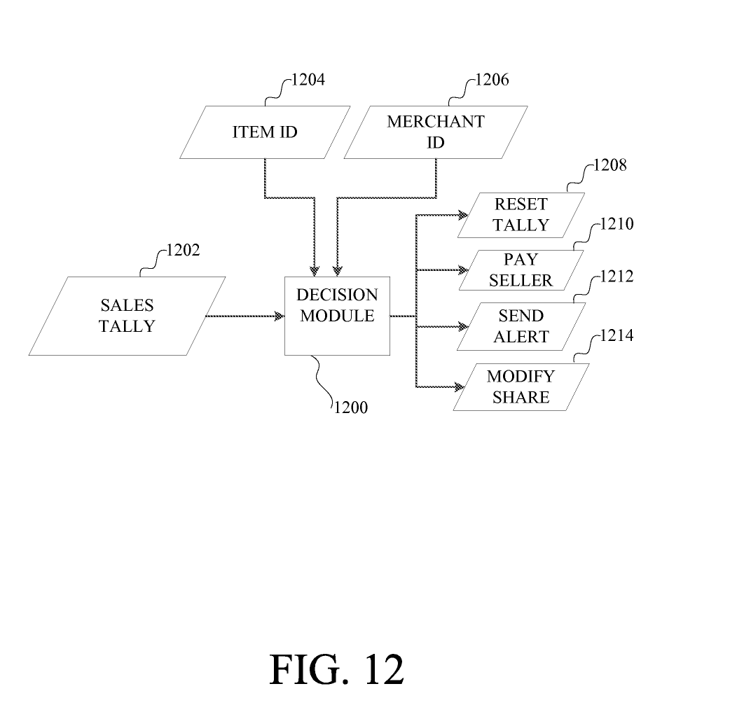

The sales tally data also can be used for other decisions in addition to secondary rules. As shown in FIG. 12, a decision module 1200 may receive a sales tally 1202 for an item (whether good or service) 1204 of a merchant 1206. Various decisions can be made, such as resetting the tally 1208 (such as if only sales within a period of time count towards the tally), paying the merchant 1210 (when the sales meet a threshold), or sending an alert or other message 1212 about the sales status of this merchant or offering to the marketplace provider. Also, a decision 1214 to modify the revenue share amount also can be made.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

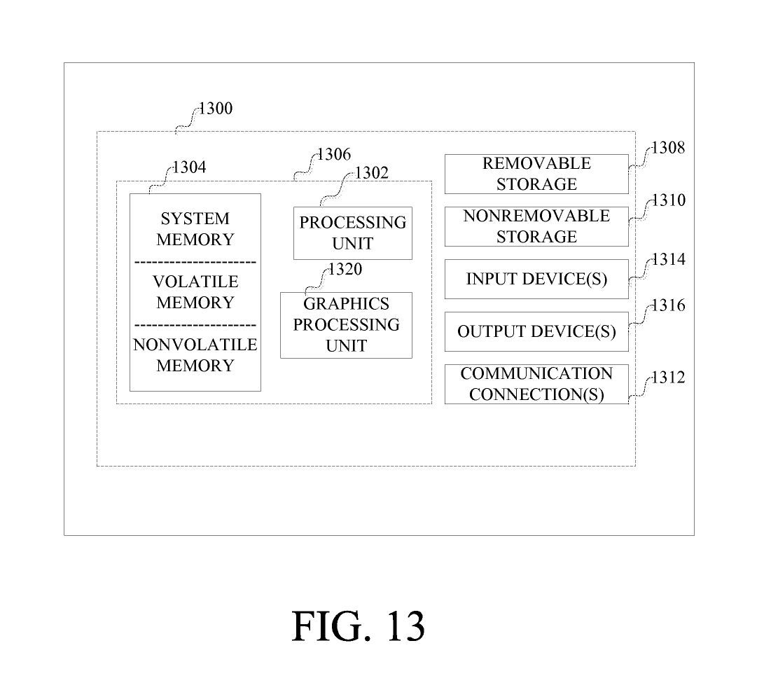

FIG. 13 illustrates an example of a suitable computing system environment for implementing any computing device used to support one or more of aforementioned components of this online marketplace. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 13, an example computing environment includes a computing machine, such as computing machine 1300. In its most basic configuration, computing machine 1300 typically includes at least one processing unit 1302 and memory 1304. The computing device may include multiple processing units and/or additional co-processing units such as graphics processing unit 1320. Depending on the exact configuration and type of computing device, memory 1304 may be volatile (such as RAM), non-volatile (such as ROM, flash memory, etc.) or some combination of the two. This most basic configuration is illustrated in FIG. 13 by dashed line 1306. Additionally, computing machine 1300 may also have additional features/functionality. For example, computing machine 1300 may also include additional storage (removable and/or non-removable) including, but not limited to, magnetic or optical disks or tape. Such additional storage is illustrated in FIG. 13 by removable storage 1308 and non-removable storage 1310. Computer storage media includes volatile and nonvolatile, removable and non-removable media implemented in any method or technology for storage of information such as computer program instructions, data structures, program modules or other data. Memory 1304, removable storage 1308 and non-removable storage 1310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 1300. Any such computer storage media may be part of computing machine 1300.

Computing machine 1300 may also contain communications connection(s) 1312 that allow the device to communicate with other devices. Communications connection(s) 1312 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 1300 may have various input device(s) 1314 such as a keyboard, mouse, pen, camera, touch input device, and so on. Output device(s) 1316 such as a display, speakers, a printer, and so on may also be included. All of these devices are well known in the art and need not be discussed at length here.

The input and output devices can be part of a natural user interface (NUI). NUI may be defined as any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence. Example categories of NUI technologies include, but are not limited to, touch sensitive displays, voice and speech recognition, intention and goal understanding, motion gesture detection using depth cameras (such as stereoscopic camera systems, infrared camera systems, RGB camera systems and combinations of these), motion gesture detection using accelerometers, gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

This online marketplace, and its dynamic rating system, may be implemented in the general context of software, including computer-executable instructions and/or computer-interpreted instructions, such as program modules or applications, being processed by a computing machine. Generally, program modules or applications include routines, programs, objects, components, data structures, and so on, that, when processed by a processing unit, instruct the processing unit to perform particular tasks or implement particular abstract data types, or otherwise configure the processing unit to implement the operations of such program modules. This system may be practiced in distributed computing environments where tasks are performed by remote processing devices that are linked through a communications network. In a distributed computing environment, program modules may be located in both local and remote computer storage media including memory storage devices.

Given the various modules in FIGS. 1, 2, 10 and 12, any of the connections between the illustrated modules can be implemented using techniques for sharing data between operations within one process, or between different processes on one computer, or between different processes on different processing cores, processors or different computers, which may include communication over a computer network and/or computer bus. Similarly, steps in the flowcharts can be performed by the same or different processes, on the same or different processors, or on the same or different computers.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving transaction data for a plurality of transactions between purchasers and merchants into memory;
for each transaction:
determining a price tier for the transaction;
determining a primary revenue sharing rule according to the determined price tier;
applying the primary revenue sharing rule to the transaction data to obtain an amount of compensation for the merchant; and
updating a database indicating a current estimated amount owed to the merchant according to the obtained amount of compensation.

2. The computer-implemented process of claim 1, further comprising, for each transaction, updating a sales tally for an item in the transaction.

3. The computer-implemented process of claim 2, wherein the transaction data for a plurality of transactions includes price information in a plurality of currencies.

4. The computer-implemented process of claim 3, wherein the sales tally for items in transactions is maintained in a single currency.

5. The computer-implemented process of claim 4, wherein updating the sales tally for the item in the transaction comprises:
identifying an amount in a currency used for the sales tally that corresponds to the price tier for the transaction;
updating the sales tally using the amount in the currency used for the sales tally.

6. The computer-implemented process of claim 5, wherein the sales tally for an item is updated at the time of a transaction involving the item.

7. The computer-implemented process of claim 6, further comprising determining when to pay a merchant according to the sales tally.

8. The computer-implemented process of claim 1, further comprising maintaining data describing a plurality of price tiers, wherein each price tier is related to a plurality of prices in different currencies, wherein the prices in the different currencies are approximately equivalent.

9. The computer-implemented process of claim 1, further comprising, for each transaction:
accessing one or more secondary revenue sharing rules;
applying the one or more secondary revenue sharing rules to the transaction data to obtain an additional amount of compensation for the merchant; and
wherein updating the database indicating a current estimated amount owed to the merchant, includes updating the database according to the obtained amount of compensation for the primary rule and the obtained amount of compensation for the one or more secondary rules.

10. The computer-implemented process of claim 9, wherein the secondary revenue sharing rule is based on a function of a sales tally for an item of the transaction.

11. The computer-implemented process of claim 1, further comprising:
maintaining a database relating price tiers to primary revenue sharing rules.

12. The computer-implemented process of claim 11, further comprising maintaining a database relating conditions to secondary revenue sharing rules.

13. The computer-implemented process of claim 12, wherein the condition is a function of sales tally for an item.

14. An article of manufacture comprising:
a computer storage medium;
computer program instructions stored on the computer storage medium which, when processed by a processing device, instruct the processing device to perform a process comprising:
receiving transaction data for a plurality of transactions between purchasers and merchants into memory;
for each transaction:
applying a primary revenue sharing rule to the transaction data to obtain a base amount of compensation for the merchant; and
applying a secondary revenue sharing rule to obtain an additional amount of compensation for the merchant, wherein secondary revenue sharing rules are defined by a condition and a revenue share, and are applied if the condition of the rule is satisfied.

15. The article of manufacture of claim 14, wherein the process further comprises, for each transaction, updating a sales tally for an item in the transaction.

16. The article of manufacture of claim 15, wherein the condition of the secondary revenue sharing rules is a function of sales tally.

17. The article of manufacture of claim 16, wherein the transaction data for a plurality of transactions includes price information in a plurality of currencies.

18. The article of manufacture of claim 17, wherein the sales tally for items in transactions is maintained in a single currency.

19. The article of manufacture of claim 18, wherein updating the sales tally for the item in the transaction comprises:
identifying an amount in a currency used for the sales tally that corresponds to the price tier for the transaction;
updating the sales tally using the amount in the currency used for the sales tally.

20. A computing machine comprising:
an online marketplace system having inputs for receiving offering data from merchants and information from purchasers and having an output providing transaction data for a plurality of transactions between the purchasers and the merchants into memory; and
a dynamic rating module having an input for receiving the transaction data, and being configure to, for each transaction, determine a price tier for the transaction, apply a primary revenue sharing rule according to the determined price tier, and output to memory an estimated amount of compensation for the merchant according to the primary revenue sharing rule for the price tier for the transaction.
